(19) United States
(12) Patent Application Publication
(10) Pub. No.: US 2021/0281886 A1
(43) Pub. Date: Sep. 9, 2021

(54) WEARABLE CAMERA SYSTEM FOR CRIME DETERRENCE

(71) Applicant: THE REGENTS OF THE UNIVERSITY OF MICHIGAN, Ann Arbor, MI (US)

(72) Inventors: Sridhar KOTA, Ann Arbor, MI (US); Kiran Mohan KOTA, Ann Arbor, MI (US); Alexander R. W. MCMILLAN, Ann Arbor, MI (US); Paul W. KEBERLY, Ann Arbor, MI (US); Lakshmi Venkatesh KAKUMANI, Ann Arbor, MI (US); Bargav NARAPAREDDY, Ann Arbor, MI (US)

(21) Appl. No.: 17/256,492

(22) PCT Filed: Jun. 27, 2019
(86) PCT No.: PCT/US2019/039438

§ 371 Date: Dec. 28, 2020

Related U.S. Application Data
(60) Provisional application No. 62/691,706, filed on Jun. 29, 2018.

(51) Int. Cl. H04N 21/218; H04N 21/432; G08B 21/10; G06K 9/00; H04W 84/02

(52) U.S. Cl. CPC H04N 21/2181; H04N 21/4325; G06F 1/163; G06K 9/00348; H04W 84/02; G08B 21/10

(57) ABSTRACT

A visible wearable device to be worn by a user having one or more housings configured to be worn by the user, one or more cameras disposed in the housing and configured to record one or more visual scenes and output one or more visual data files, one or more power sources for powering the one or more cameras, and one or more transmitters transmitting the one or more visual data files to a location remote from the user. The stored data to be released only in response to an order of a court of competent jurisdiction.

### CROSS-REFERENCE TO RELATED APPLICATIONS

This application claims the benefit of U.S. Provisional Application No. 62/691,706, filed on Jun. 29, 2018. The entire disclosure of the above application is incorporated herein by reference.

### FIELD

The present disclosure relates to a wearable camera system for crime deterrence.

### BACKGROUND AND SUMMARY

This section provides background information related to the present disclosure which is not necessarily prior art. This section provides a general summary of the disclosure, and is not a comprehensive disclosure of its full scope or all of its features.

Larceny-theft and assault are significant issues in today's societies. US crime statistics provided by the FBI, Bureau of Justice, and RAINN (Rape, Abuse and Incest National Network) indicate that a significant number of larceny-theft and assault cases were perpetrated, and very few led to incarceration of the perpetrator. Many times, the lack of prosecution is based on the associated lack of video, audio, eyewitness, or other evidentiary data to support arrest and conviction.

To more fully evaluate these crimes and the need for a viable solution, the number of larceny-thefts and assault cases were examined. Based on 2017 US crime statistics recorded by the FBI, it was determined that approximately 5.5 million larceny-thefts occurred, and 810,000 aggravated assaults were reported. Moreover, studies by RAINN (Raped, Abuse and Incest National Network) concluded that only 627 of 1000 cases of assault and battery and 619 of 1000 robbery cases are reported to authorities. This suggests that roughly ⅓ of these crimes go unreported, suggesting that the statistics provided by the FBI are likely underestimates of the number of these crimes committed in the United States.

The number of cases leading to arrest and jail time were further examined. Again, 2017 US Crime Statistics provided data on number of arrests made, and it was found that about 390,000 arrests were made for aggravated assault, and 950,000 for larceny-theft. This indicates that only 17% of larceny-thefts and 48% of aggravated assaults led to arrest. Estimates from RAINN provided another reference point for this data—RAINN estimated that only 167 of 1000 robbery cases and 255 of 1000 assault cases lead to arrest. Consequently, it is clear that there that a substantial number of personal crimes go unreported and further fail to result in arrests and convictions.

Notwithstanding the above, the locations that larceny-thefts and assaults tend to occur was investigated. The Bureau of Justice collected data from 2004-2008 that showed that 39.1% of purse-snatchings and pickpocketing occurred in commercial buildings, and 28.2% in public spaces. Additionally, the National Criminal Justice Reference Service (2015) indicated that for female victims, 27% of assaults occurred in a public space, and 56% occurred at or near the victim's home.

Consequently, there exists a need in the relevant art to provide a solution to help report such personal crimes or other issues and provide contributory evidence sufficient to support convictions in a court of law.

Therefore, according to the principles of the present teachings, a visible wearable device (called I-Witness) is provided having a miniature camera system usable as a crime deterrent and means for obtaining and securely, privately, and reliably providing evidence of the same. In some embodiments, the camera system may comprise at least one camera or, in some embodiments, may comprise a primary camera and one or more secondary cameras.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a front perspective view illustrating a visible wearable device according to some embodiments of the present teachings;

FIG. 1B is a back view illustrating the visible wearable device of FIG. 1A;

FIG. 1C is a side perspective view illustrating the visible wearable device of FIG. 1A;

FIG. 2A is a front perspective view illustrating a visible wearable device according to some embodiments of the present teachings;

FIG. 2B is a side perspective view illustrating the visible wearable device of FIG. 2A;

FIG. 2C is a back view illustrating the visible wearable device of FIG. 2A;

FIG. 3A is a front circuit view illustrating the visible wearable device according to the principles of the present teachings; and

FIG. 3B is a back circuit view illustrating the visible wearable device according to the principles of the present teachings.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the wearable device 10 in use or operation in addition to the orientation depicted in the figures. For example, if the wearable device 10 in the figures is turned over, elements described as “below” or “beneath” other elements or features would then be oriented “above” the other elements or features. Thus, the example term “below” can encompass both an orientation of above and below. The wearable device 10 may be otherwise oriented (rotated 90 degrees or at other orientations) and the spatially relative descriptors used herein interpreted accordingly.

In accordance with the principles of the present teachings, a visible wearable device 10 (called I-Witness) is provided having a miniature camera system 116 meant to ultimately serve as a crime deterrent and law enforcement system that is particularly configured to maintain the privacy of its users and any unintended individuals. In some embodiments, as will be discussed in detail, the camera system 116 may comprise at least one camera 16 or, in some embodiments, may comprise a primary camera 16 and secondary camera 18. For the purpose of this disclosure, the camera system 116 will be referred to generally as a camera system 116; however, it should be understood that this may include one or a plurality of cameras.

Efficacy of Crime Deterrents

However, prior to discussion of the particulars of the present teachings, it may be beneficial to discuss the efficacy of crime deterrents.

Generally speaking, the certainty of being caught in the commission of a crime is a vastly more powerful deterrent than the potential of punishment. That is, research indicates that the chance of being caught is a vastly more effective deterrent than even draconian punishment.

Previously, public surveillance camera systems have been used as a cost-effective way to deter, document, and reduce crime. Research has shown that in Baltimore and Chicago, for example, cameras were linked to reduced crime, even beyond the areas with camera coverage. The cost savings associated with crimes averted through camera systems in Chicago saved the city over four dollars for every dollar spent on the technology, while Baltimore yielded a 50-cent return on the dollar. The usefulness of surveillance technology in preventing and solving crimes depends on the resources put into it.

The deterrent effect is further supported by research conducted by the University of North Carolina Charlotte, Criminal Justice, 60% of convicted burglars indicated they would first determine whether a home had a security camera before breaking in—and 40% of them would seek another easier target, if surveillance cameras were found.

Similarly, a survey of Electronic Security Association, 83% of thieves would first determine whether a home has a CCTV camera before committing an intrusion—and 60% of them would typically avoid homes with security cameras.

Therefore, it can be concluded that crime deterrents are successful in reducing crime.

Privacy Concerns

However, the use of cameras and other audio and/or video recording leads to a legitimate concern for the privacy of the users, homeowners, and others whom are not committing a crime and have a reasonable expectation of privacy. Thus, with the use of body cameras, for example, becoming increasingly popular and thus continuously and unknowingly taking images, videos, and voice recordings of people, there exists a legitimate concern regarding a breach of privacy.

Currently, there are very few laws and regulations regarding the use of body cameras in public. The primary concern with body camera footage is that it could violate one's privacy. To address this, some states have passed laws that define situations where privacy is a right. Most laws specify a “reasonable expectation of privacy” is in one's home or private property. If evidence of a crime is recorded in one's home, then the potential for search and seizure would be considered unconstitutional. However, courts have not ruled against stationary surveillance cameras outside of the home because it assumed that one cannot expect privacy on the street.

While the American Civil Liberties Union (ACLU) states the use of body cameras is beneficial to the public, it cautions against the way the footage is used. The ACLU say that the footage must be stored in a way that is unable to be modified. Courts suggest establishing a set of guidelines to specify how the videotapes are handled and demonstrate what steps are taken to preserve the original files. When handled properly, videos can be more reliable than an eye witness.

Another concern is the release of the video itself. The ACLU recommends that recording should not be viewed unless there is a “reasonable suspicion of a crime.” The use of body cameras begin to be detrimental to the public when videos released show embarrassing footage, footage that is used to identify subjects in additional crimes, or impact community relationships. In Washington State, a Privacy Act was passed that states that the disclosure of information about a person would be a breach of privacy only when the information is highly offensive to a reasonable person, and is not a legitimate concern to the public.

However, as will be discussed herein, these privacy concerns are not an issue with regarding to the principles of the present teachings, as its permits numerous benefits and addresses such privacy concerns in a systematic, reliable, and private manner. Accordingly, the present teachings provide a system that is useful as a crime-deterrent and balance the detrimental issues relating to privacy.

Visible Wearable Device

As set forth herein, in accordance with the principles of the present teachings, visible wearable device 10 (called I-Witness) is provided having a miniature camera system 116. In some embodiments, as described herein, visible wearable device 10 is configured to serve as a crime deterrent and/or law enforcement system. In some embodiments, as described herein, visible wearable device 10 is configured to maintain the privacy of its users and any unintended individuals who may be otherwise recorded via audio, video, data assembly, or other information.

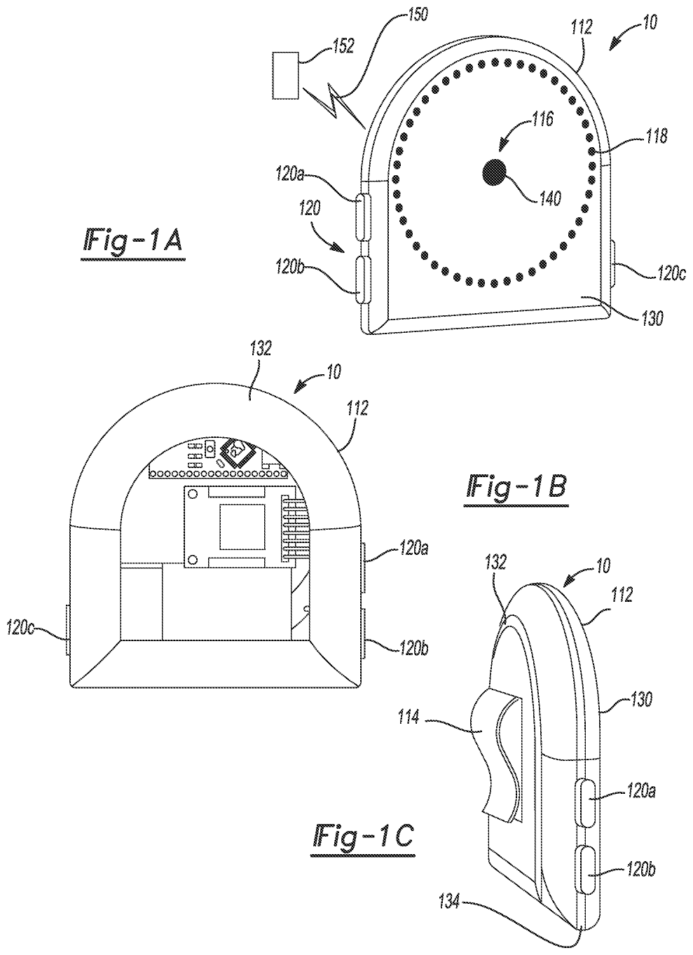

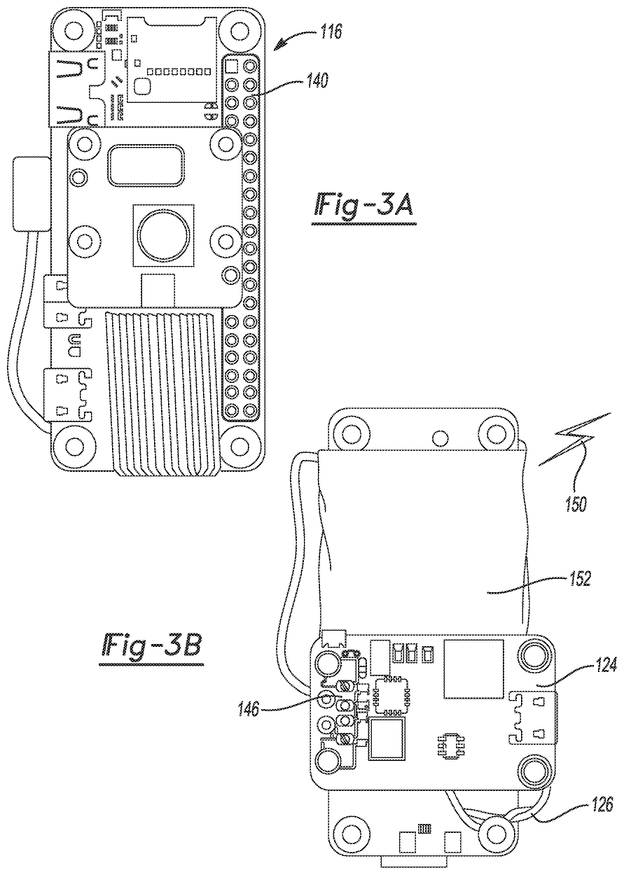

With particular reference to FIGS. 1A-3B, in some embodiments, the visible wearable device 10 can comprise a housing 112 having a coupling system 114, a camera system 116, an optional light system 118, one or more activation switches 120, a power source 122, an operation and communication system 124, a detection system 126, and/or combinations thereof.

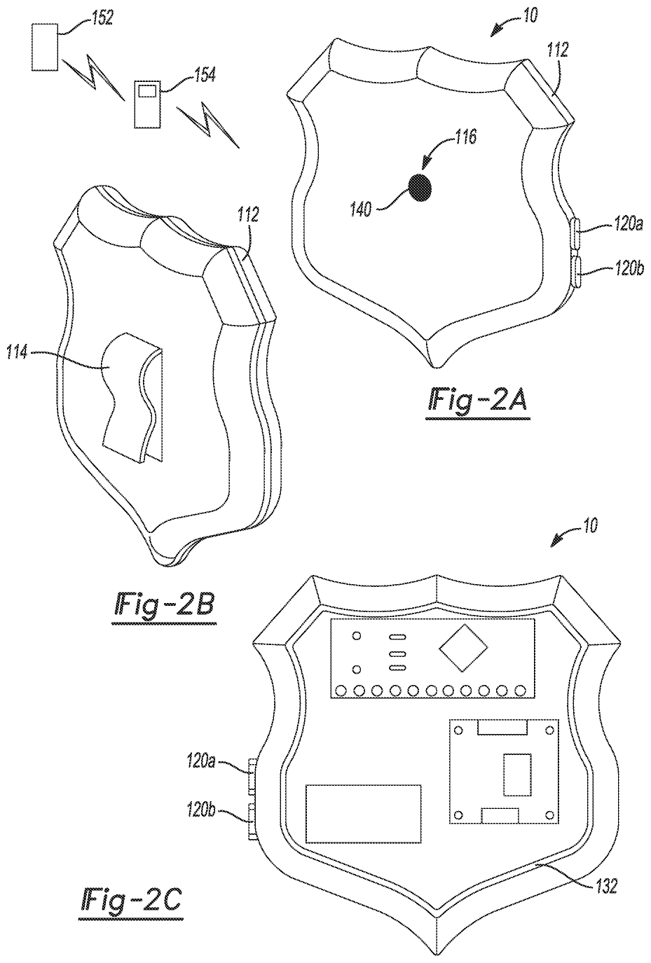

In some embodiments, as illustrated in FIGS. 1A-2C, housing 112 can comprise any suitable structure configured to contain and protect the associated components and systems of visible wearable device 10. In some embodiments, housing 112 can comprise a generally planar structure having a front face 130, a rear face 132, and a sidewall structure 134 extending between the front face 130 and the rear face 132. In some embodiments, as illustrated in FIGS. 1A-1C, housing 112 may be generally dome shaped. In some embodiments, as illustrated in FIGS. 2A-2C, housing 112 may be generally shield shaped to generally resemble a law enforcement badge. In some embodiments, the housing 112 can be made of a material and/or structure that is generally resistant to impact or other trauma. Moreover, in some embodiments, the housing 112 can be made of a color that is prominent and suitable to alert a would-be criminal or attacker of the presence the visible wearable device 10. However, it should be appreciated that in some embodiments, a concealed version may be desired. By way of a non-limiting example, in some embodiments, housing 112 is generally three (3) inches high, four (4) inches wide, and about 0.6 inches thick. However, it is anticipated that housing 112 can be any size (e.g. smaller or larger) than this exemplary size.

In some embodiments, housing 112 comprises coupling system 114 for attaching visible wearable device 10 to a user. In some embodiments, coupling system 114 includes a clip, bracket, loop, slot, channel, or other device for reliably fastening housing 112 to the user. It should be understood that in some embodiments, housing 112 and coupling system 114 can be integrally formed and/or formed as part of another device or product, such as a hat, jacket, backpack, glasses, harness, buckle, vest, or other item. Moreover, in some embodiments, housing 112 is configured to be placed and/or positioned in a vehicle (e.g. dashboard) to serve as a crime deterrent and/or obtain evidence of a crime. Likewise, wearable device 10 and/or housing 112 can be incorporated into a wearable garment (e.g. vest, shirt, coat, etc.) such that mounting and use of the wearable device 10 is simple and convenient to employ.

In some embodiments, the camera system 116 may comprise at least one camera 140 or, in some embodiments, may comprise a primary camera 140 and secondary camera that can be worn on another portion of the user (e.g. user's back, hat, eyeglasses, backpack, or similar). In some embodiments, camera 140 and optional secondary camera can be a fisheye type camera to provide near or complete 360 degree visual coverage around the user. For the purpose of this disclosure, the combination camera system will still be referred to generally as camera system 116; however, it should be understood that this may include one or a plurality of cameras and/or other components. In some embodiments, camera system 116 will be of sufficient quality to capture a clear image of people or objects around the user. By way of non-limiting example, in some embodiments camera 140 is an infrared camera that is capable of recording without the need for supplemental lights, such as from optional light system 118.

In some embodiments, however, optional light system 118 can provide light output to improve and/or enhance image recordation and quality. However, it should be appreciated that optional light system 118 can further be used as a deterrent to indicate that recording is currently active and that a criminal's identity and actions are being recorded (and transmitted). Moreover, in some embodiments, the output of light system 118 can be sufficient to provide a debilitating effect in the criminal—that is, the light output being sufficiently intense to cause temporary blindness and/or disorientation. This can further be achieved via continuous intensity output and/or intermittent output (i.e. strobe effect). The strobe effect can be timed to further permit illumination of the criminal for recordation purposes, thereby serving a dual purpose. By way of non-limiting example, in some embodiments light system 118 can comprise a plurality of LED (i.e. 48 LEDs).

One or more activation buttons 120 can be used to control operation of visible wearable device 10. As illustrated in FIGS. 1A-2C, activation buttons 120 can comprise one or more buttons as desired. In some embodiments, a first button 120a can be used as a first stage activation. In this first stage, first button 120a can be depressed and released to activate light system 118 to provide illumination of an unfamiliar situation, location, or in response to an unsafe condition. As described herein, activation button 120a can serve to “wake” visible wearable device 10, or, in some embodiments or conditions, visible wearable device 10 can be in a STANDBY mode in which recordings are activated at a predetermined interval and activation button 120a is controlling only light system 118.

In some embodiments, additional activation buttons 120b, 120c can be used to provide additional control and functionality. In some embodiments, simultaneous depressing of activation buttons 120b, 120c can initial an ALERT mode in which light system 118 is activated and/or recording and transmitting of images, audio, and data (e.g. location information) to a remote server is fully continuous, real-time, and autonomous. Moreover, depressing activation buttons 120b, 120c can result in an alert being sent to authorities (e.g. police). To facilitate operation of activation buttons 120, alternative shapes, colors, or detents can be used to enable tactile response. In some embodiments, the software will automatically alert authorities, family, and/or friends if it determines that the user is in danger based on analysis of the images, audio, video, and/or other information recorded.

In some embodiments, power source 122 is provided to provide operational power to any one or more of the associated systems and components of visible wearable device 10 according to known principles. Power source 122 can comprise a rechargeable battery, a solar power system, a capacitive system, an inductive system, a self-charging system (e.g. powered by movement of the user), user's cellular telephone or the like, or a combination thereof. It should be appreciated that in some embodiments power source 122 can comprise a redundant power system sufficient to power the systems of visible wearable device 10 in the effect a primary power system fails or is circumvented. To this end, a secondary system can be used to sufficiently, or at least temporarily, provide power to transmit a final alert signal and any final images or files.

In some embodiments, operation and communication system 124 can be operably coupled to each of the components and systems of visible wearable device 10 to provide the operational backbone of the system. In some embodiments, operation and communication system 124 provides onboard operation of the system, including activation of light system 118, camera system 116, periodic and continuous recordation, and/or transmission of files, information, and/or data.

In some embodiments, operation and communication system 124 comprises a location system 146. In some embodiments, location system 146 comprises a GPS location system that is configured to determine location of visible wearable device 10 and the associated user within the global positioning system. In some embodiments, operation and communication system 124 can comprise a transmission system 150 configured to transmit any and all information to a server 152. Generally, server 152 can be a physical server, a virtual server, a cloud based system, and the like. In some embodiments, server 152 is private and access is highly controlled and only available subject to court order. It should be understood that such any and all information can comprise still images, video images, audio recordings, location information, movement information, impact information, time information, user information, and any other useful information, such as local WIFI information, local cellular information, or other identifiable information. Transmission of this information can be via any system, such as WIFI, adhoc WIFI, Bluetooth, near field communication (NFC), QR code sharing, local hotspot, RF long polling, cellular, satellite, designated emergency frequencies, modem (e.g. 2G, 3G, etc.) or other preferred system. It should be understood that, in some embodiments, transmission system 150 can leverage the use of a locally available communication system for relaying information to server 152. In other words, transmission system 150 can transmit information from an internal transmitter or communication system disposed within housing 112 (e.g. a wireless, wired, or other communicator) to send low power signal(s) to a locally available network to then be sent to server 152. The locally available network can comprise a user's cellular telephone (see 154 in FIG. 2A), a locally available WIFI, or other system. This can serve to provide a low power solution for transmission capable of extending the life of power source 122. When using a user's cellular telephone as an intermediate relay and/or communication system, software can be implements on the user's cellular telephone to provide discrete pairing (e.g. wearable device 10 recognizes and/or securely communications with cellular telephone 154 and vice versa). Communication between wearable device 10 and cellular telephone 154 can further be used a) to track the battery level of the wearable device 10 to aid the user in charging device 10; b) as a (secure) switch to turn-off the device when not in use; c) for soft messaging (based on the danger/severity level classified, notify (push notification/SMS/Call) the user to confirm; if no response is received, dynamic escalation of the situation like inform to near and dear, inform authorities, or call 911 automatically); d) to request user to enter “start location” and “destination”, so as to can identify danger if there is a significant detour/no movement for a long time, etc.; and e) to leverage the use of sensor data of cellular telephone 154, such as but not limited to GPS, accelerometer, and gyroscope for improved functionality and/or reduced size of wearable device 10.

In some embodiments, detection system 126 can be a separate system or integrally formed with operation and communication system 124. In some embodiments, detection system 126 can employ logic or other Artificial Intelligence to determine occurrence of an attack, removal of visible wearable device 10, or other important parameter. In some embodiments, detection system 126 can comprise one or more accelerometers and/or gyroscopes for location, movement, direction, velocity, and/or acceleration information. In some embodiments, the accelerometer and/or gyroscopes can detect an impact or shock caused by throwing the wearable device 10 or any attempts to crush the wearable device 10. In an event, the wearable device 10 senses such an impact or shock, an SOS signal or other signal can be transmitted to the nearest police station. It should be understood that, in some embodiments, detection system 126 can leverage the use of a locally available systems for detecting location, movement, direction, velocity, and/or acceleration information. In other words, detection system 126 can obtain information from an internal system or component disposed within housing 112 or can leverage a user's cellular telephone (see 154 in FIG. 2A) to obtain GPS and other information. This can serve to provide a low power solution for information gathering capable of extending the life of power source 122.

Operation

The visible wearable device 10, when turned on, is designed to record still photos, record live video, and/or record live audio at predetermined intervals, such as but not limited to every 10 seconds. The visible wearable device 10 is further designed to continuously transmit, via operation and communication system 124, the recorded image(s), video/audio, and other information to a remote computer system or server 152.

Once the camera system 116 is turned on, the process of recording, transmitting and storing the information may continue for an extended period for up to 48 hours. The wearable device 10 can be turned on with an “ON” switch (e.g. activation button 120a) and there will be no means available on the wearable device 10 to stop the recording and transmitting of the information; that is, there will be no “OFF” switch. In some embodiments, the recording can be turned off by the registered user or proxy online via a pre-registered and/or pre-authorized computer. It should be understood that in some embodiments, power source 122 may last 2-9 hours, depending on the size, for transmitting data to a remote server 152. The data may be stored for 48 hours or longer. If the visible wearable device 10 and/or server 152 determine that the user is safe (based on evidence of normal daily activities) after 48 hours, the stored data may be manually or automatically deleted or the user may be contacted to ensure safety and seek permission for deleting of stored data. The data will not be erased and the device may continue to record if there is any suspicion of user not being safe.

The packets of information comprising image/audio/video can be stamped with date, time, and GPS coordinates, obtained from location system 146, and can be transmitted upon activation of an internal trigger once a file size reaches a certain value or upon some other trigger (described herein). The recorded images and videos will not be stored on the wearable device 10 once they are transmitted to the remote server 152.

Information Transmitted and Stored

The contents of the information packet(s) thus transmitted to the remote server 152 will be stored at the remote location. In some embodiments, this remotely stored information (RSI) is contained in a remote file folder (RFF) designated to the registered user of the wearable device 10. RFF can store RFI of the last 48 hours (maximum remote file storage space) in a continuous recording mode.

The remotely stored information will not be released or disclosed or otherwise made available in any form to any individual, including the owner of the wearable device 10, unless a court issued order makes an official request to the business entity (Company) responsible for administering the remotely stored information. Upon receipt and verification of such court order, the Company will release RSI to a designated court official for consideration in a criminal court proceeding. Thus, the RSI will be released only if the court decides a crime or an attempted crime was committed against the person wearing the wearable device 10 and the RSI could serve as a potential eyewitness to the crime.

Since the information (photo, audio, and video) is continuously transmitted to a remote server 152, the contents of the wearable device 10 at any time will be minimal at best. The wearable device 10 may comprise a separate switch (e.g. activation buttons 120b, 120c) when activated to alert the nearest police station with GPS location of the wearable device 10.

The wearable device 10 has two (2) distinct patterns for transmitting images and video: threshold mode, rapid succession mode. In threshold mode, the wearable device 10 stores video until either a sizing or timing threshold is reached, at which point the wearable device 10 securely transmits its image and/or video cache to one or more remote computing systems for archive and retrieval. In contrast, rapid succession mode enables the wearable device 10 to transmit a copy of local images and video as the files become available on the system.

In some embodiments, the modem/operation and communication system 124 and its power source 122 are not included in the wearable device but are part of a third-party device (such as a cell phone) supplied by the user. In this configuration, the wearable device 10 will include means to interface with the third party device, via a wired or wireless connection, in a way that is controlled by the user. The wearable device may include the means to detect that the third-party was connected or disconnected, and exit or enter, respectively, a low-power or “OFF” state.

Artificial Intelligence

As discussed herein, wearable device 10 is configured to provide deterrence to any malicious attack. Wearable device 10 is programmed to take periodic snapshots in its field of view. Initially, it is an object of the present teachings to ascertain if the user is in danger. Additional artificial intelligence can be used. To this end, a user wearing wearable device 10 is likely to have the camera face a direction that is in front or rear of the user. Using this as information, the present invention can estimate how much of the skyline is detected in a normal circumstance as compared to when an attack occurs and/or when wearable device 10 is thrown facing up side on to the ground. This can be used as a metric of danger classification.

Moreover, AI can detect if the camera field of view changes considerably over multiple snapshots as another metric to detect danger classification. Similarly, if wearable device 10 is detecting a particular scene for a predetermined amount of time, then recording mode can be triggered to ascertain more details into the context of the scene, to serve as a warning indicator. Likewise, a still field of view from the wearable device 10 can show a dynamic environment in the real world. It is anticipated that by employing some nearest neighbor methods to eliminate such dynamic object in image frames and only focus on the static bits to pull the recording trigger, warning flags can be deduced. The absolute differences between images are also considered in this decision-making process.

Deep Learning based AI can be used to perform classification tasks like image segmentation tasks to derive contextual relation between objects captured in an image by the device thus enabling better decision-making process as a result to perform danger classification.

The AI can also leverage machine learning models on audio processing methods that could be employed to analyze audio snippets captured and transmitted by the device to detect and classify the following categories but not limited to sentiments, emotions of the user and subjects in his proximity as picked up the device and to estimate the semantics of the environment the user might be in.

The AI can also serve towards protecting user interests and ownership of the device by employing accelerometer data to capture and train the changes in it using Machine Learning techniques to perform gait recognition of the user leveraging the fact that gait is approximately unique to a person, thereby detecting cases if the device is in hands of a subject not intended as the user.

File Structure Methodology

In some embodiments, the wearable device 10 utilizes the Open CV 3.0 computer vision library for interfacing with USB and proprietary bus camera/optical modules. OpenCV is an open-source computer vision library licensed under the 3-clause BSD License. The library itself can be written primarily in C++ with its primary interface into the library being from C++. However, bindings exist for the library in Python, Java, and Matlab/Octave. OpenCV encodes video using MPEG1/MPEG2/MPEG4, VC1, H264/H264-SVC/H264-MVC, and JPEG video encoding formats.

In some embodiments, a propriety library was written to handle the various functions required for intended camera device operation. The library itself wraps certain OpenCV 3.0 API calls and adds proprietary methods that facilitate intended device operation. The library is split into four (4) logical components: recorder, packager, transmitter, watcher.

The coordinator serves as the main entry into the program. Its main purpose is to coordinate the recording, encoding, storage, and transmittal activities of the camera device. The watcher can either be started from the command line or using an init system such as SysVinit or Systemd. At startup, an empty file-watcher, video-recorder, and image-recorder object are instantiated. The coordinator is started by executing the “go” method. The “go” method sequentially executes several additional methods.

The first of these methods is the loading of settings from a JSON file. This file contains information such as the recording mode {image∥video}, encoder {MPEG1, MPEG2, . . . , etc.}, video file extension {.avi, .mkv, m4v, . . . , etc.}, archive format {.tar, .tar.bz, .tar.gz, .zip}, image resolution {640×480, 768X 576, 800x600, etc}.

The watcher parses the file to instantiate either a video-recorder or image-recorder object a file-watcher, and a sender, and initializes all settings. Additionally, a list of desired network interfaces is loaded.

The second method executed by the “go” method is the “Network Info” method. This method detects the networking settings corresponding to the interfaces defined in the settings JSON file. The method returns the IP address and MAC address for each identified interface.

The third method executed by the “go” method sets the attributes loaded from the settings file. It is at this point that the empty recorder object is populated with encoder method, resolution, and output file location. It is also at this point that the watcher object is populated with either the file name of the file to be watched (for threshold mode), or the watcher is populated with the directory name (for use with rapid succession mode).

Once the appropriate attributes have been set on the recorder and watcher objects, the objects are started as worker processes running in their own threads. It is at this point that the Coordinator begins listening to the watcher for status messages.

The recorder is an object that can be thought of as a simple state machine that records video, image, and audio data. It is not capable of starting or stopping itself and relies upon commands executed by its parent process, the Coordinator, to set its attributes and execute its available functions.

The packager is an object that can also be thought of as a simple state machine that packages audio, video, and images into an archive file for transmittal. As with recorder, it is not capable of starting or stopping itself and relies upon commands executed by its parent process, the Coordinator to set its attributes and execute its available functions.

The transmitter is an object that additionally can be thought of as a simple state machine. Its primary responsibility is the transmittal of packaged audio, video, and images across internal and external networks for archive on on remote servers (the cloud). Like the packager and the recorder, the transmitter is not capable of starting or stopping itself. Commands to transmit packaged files may either come from the Coordinator (threshold mode), or may be automated (rapid succession mode).

In rapid succession mode, the Transmitter includes watching functionalities over which it may watch one or more directories for file creation, deletion, or modification. In this mode, the Transmitter searches for the creation of files matching a particular pattern. For example, the pattern for an aggregation of video files may have the file extension.tar.gz. Similarly, an image file may the file extension .jpg. The patterns are set in the settings.json file and are thus extensible. Overall, inclusion of a watcher pattern enables the immediate transmittal of data and is most suitable for rapid succession mode.

Regardless of mode, the transmitter transmits its data using Secure Shell (SSH) transport stream and the Secure File Transfer Protocol (SFTP). Alternative forms of transmission may include transmission over a network socket using SSL/TLS, or HTTP over TLS/SSL (HTTPS).

In some embodiments, the Wi-Fi and/or cellular (mobile) networks can comprise generic TCP-IP networks such as but not limited to Wireless Local Area Networks (802.11), Ethernet (802.3), HSPA/HSPA+(3G), LTE.

In some embodiments, the wearable device 10 records still images at certain intervals, and records video at a desired effective OR true frame rate, and audio at an effective (Variable) or fixed bit rate, and then transmits the aggregated data to a remote location. However, the audio and video data may also be streamed across a network in real-time where it may be stored as raw data or may be down-sampled based upon the remote storage policy.

The default mode for the wearable device 10 is to transmit all data packets as encrypted packets using SSL/TLS authentication with asymmetric or symmetric encryption for authentication between device and a remote storage system, and encrypted transmittal and remote encrypted storage of audio, video, and spatio-temporal metadata.

Data authentication and data transmittal can take place at the session, presentation, or application layer of the OSI model. An application layer example using may include HTTPS.

For streaming purposes the applicable portions of MPEG-4 specification may be utilized to encrypt audio and video using DRM, and/or may be accomplished using TLS encryption.

All spatio-situational metadata, audio, and video data is encrypted either through the use of AES. This may be supplemented or replaced by the usage individually encrypted partitions for storage of audio, video, and spatio-temporal metadata. Furtherto, such encryption may be augmented or replaced with whole-disk encryption. All of these methods are not to be replaced with, but to supplement access controls. AES file encryption is the minimum requirement with access control.

Finally, cryptographic operations for various operations described herein require the usage of an independent on-board crypto-processor (A microprocessor or microcontroller for execution of cryptographic operations and persistence of cryptographic artifacts for authentication and storage). Such examples may include but are not limited to the facilities of devices such as a Trusted Platform Module (TPM) or a Zymbit Zymkey interfaced either as a separate module with communication using protocols such as I2C, SPI, SMBus, or as an integrated chip that communicates directly with the main computer processor.

Additionally, encoding of audio and video data is accomplished via the usage of an onboard FPGA/Microprocessor/Microcontroller. (AV Encoder/Decoder). This can be accomplished either using a separate onboard module or integrated chip. This dedicated FPGA/Microcontroller/Microprocessor also handles cryptographic operations and other operations specifically for the case of DRM usage.

Two-way communication between the dedicated cryptographic processor and the AV Encoder/Decoder to synchronize/coordinate recording and encryption such that persistence of audio, video, and spatio-temporal artifacts on disk are immediate. In a similar fashion, two-way communication may also be accomplished to handle situations for which data is streamed, allowing for encrypted audio, video and spatio-temporal data from the moment of capture through arrival at desired location.

Trust Protocol

In some embodiments, visible wearable device 10 can establish a trust protocol or confirmation with the computing cloud is via a provisioning mechanism where the cloud provides visible wearable device 10 with one (1) private key, one (1) public certificate that contains a public key, and one (1) copy of the cloud's certificate. The cloud's certificate may have a fully qualified domain name (FQDN) that is generic such as “storage.example.com<http://storage.example.com>.” That is one (1) or more servers that compose the cloud may have that certificate and present itself as the cloud. In other words, “storage.example.com<http://storage.example.com>” may correspond to one (1) or more IP addresses that are registered with a public DNS server. The “storage” portion of the URL “storage.example.com<http://storage.example.com>” thus refers to a service provided by the domain “example.com<http://example.com>,” and while the data from the wearable to “storage.example.com<http://storage.example.com>” may be transmitted to a single IP address for storage, a replication mechanism exists to replicate one or more portions of the wearable's transmitted to multiple cloud servers.

It should be understood that there are also technologies that could be used to transmit different portions of say, a video stream housed on the visible wearable device 10, to different servers. That is, a group of servers may each get a different portion of the wearable's transmitted data, and then after the wearable finishes data transmission the cloud servers exchange their portions of the data received such that each server gets one (1) whole copy of the complete data once the different servers exchange their data bits.

During the provisioning process itself, the cloud's certificate is added to the wearable's trust-anchor store, while the assigned private key is placed into the cryptomodule/cryptostore of the wearable. That is, the cloud assigns the wearable's identity. The public certificate is used during SSL/TLS authentication to say “this is me.” When the wearable initiates a connection with the cloud, the cloud can confirm that the wearable is a device whose identity is known since it assigned the wearable's identity. Likewise, the wearable can use the cloud's public key that was given during provision and stored in the wearable's trust-anchors, to verify the cloud's identity. This is commonly referred to as a “handshake.” The connection switches over to an encrypted connection once the wearable and cloud confirm each other's identity. The private key of the wearable is then retrieved from the wearable's cryptomodule to encrypt the data file and/or the transport stream used to carry the data to the cloud. The two-way identity confirmation and subsequent transmittal over encrypted transport stream enables the wearable to store its recorded audio, video, image data on the cloud's storage facilities. In some embodiments, each wearable could be assigned a special directory where the data could be stored, where each wearable only has access to its own directory and can neither read nor obtain the contents of any other wearable's directory on any of the cloud servers. Only a server service with root permissions, or individual (administrator/root) with root permissions can read, edit, and/or see the contents of all wearables.

It is important to note that a cloud may assign more than one set of private keys+public certificate, since different keys may be used to sign data (vouch for the integrity of the data as being from a particular wearable), encrypt data (used by a wearable to obscure the data bits in file and additionally to obscure the bits during transport. The cloud actually gets to decide what the intended purpose of each key is for that it assigns to a wearable. It's the responsibility of the wearable's software stack to honor key usage and ensure that the correct key is used for the correct purpose. For example, the key used to encrypt the wearable disk may not be the same key used to encrypt the transport stream. Furthermore, the wearable key used to sign the contents of an archive file may not be the same that is used to encrypt the wearable disk, or transport stream.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A visible wearable device to be worn by a user, the system comprising:
a housing configured to be worn by the user;
a first camera disposed in the housing, the first camera being configured to record a visual scene and output a visual data file;
a power source for powering the first camera; and
a transmitter system transmitting the visual data file to a location remote from the user.

2. The visible wearable device according to claim 1 further comprising:
a global position system (GPS) receiver disposed in the housing, the global position system configured to receive global positioning coordinates of the housing and output a GPS data file, and
the transmitter system transmitting the GPS data file to the location remote from the user.

3. The visible wearable device according to claim 1 further comprising:
an accelerometer configured to detect a shock or impact and output a detection alert, and
the transmitter system transmitting the detection alert.

4. The visible wearable device according to claim 3 wherein the accelerometer is disposed in the housing.

5. The visible wearable device according to claim 3 wherein the accelerometer is disposed in a device separate from the housing.

6. The visible wearable device according to claim 1 further comprising:
a switch member disposed in or on the housing, the switch member configured to output a response signal when manually actuated by the user, and
the transmitter system transmitting the response signal.

7. The visible wearable device according to claim 1 further comprising:
a second housing configured to be worn by the user;
a second camera disposed in the second housing, the second camera being configured to record a visual scene and output a visual data file;
a second power source for powering the second camera;
a second system transmitter transmitting the visual data file to the location remote from the user.

8. The visible wearable device according to claim 1 wherein the transmitter system continuously transmits the visual data file to the location remote from the user.

9. The visible wearable device according to claim 1 wherein the transmitter system periodically transmits the visual data file to the location remote from the user.

10. The visible wearable device according to claim 1, further comprising:
securely storing the visual data file at the location remote from the user.

11. The visible wearable device according to claim 1 wherein the transmitter system comprises a communication system configured to communicate to a cellular telephone, the cellular telephone configured to receive the visual data file from the communication system and transmit the visual data file to the location remote from the user.

12. A visible wearable device to be worn by a user, the system comprising:
one or more housings configured to be worn by the user;
one or more cameras disposed in the housing, the one or more cameras being configured to record one or more visual scenes and output one or more visual data files;
one or more power sources for powering the one or more cameras;
one or more transmitters transmitting the one or more visual data files to a location remote from the user.

13. The visible wearable device according to claim 12 wherein the one or more transmitters comprises a cellular telephone.

14. The visible wearable device according to claim 13 wherein the cellular telephone is wirelessly coupled to a transmitter disposed within the one or more housings for receiving the one or more visual data files, the cellular telephone configured to receive the one or more visual data files and transmit the visual data file to the location remote from the user.

15. A method of storing and retrieving data, the method comprising:
providing a media system relative to a user;
collecting at least one of video data, audio data, and photographic data from the media system;
monitoring location information of the user;
continuously wirelessly transmitting at least one of the video data, audio data, and photographic data to a remote computer, the remote computer being separate from the user;
wirelessly transmitting the location information to the remote computer; and
disclosing at least one of the video data, audio data, photographic data, and location information only in response to an order of a court of competent jurisdiction.

16. The method according to claim 15 further comprising extracting the photographic data from the video data.

17. The method according to claim 15 further comprising analyzing at least one of the video data, audio data, and photographic data to determine a likelihood of danger to a user.

18. The method according to claim 15 further comprising analyzing accelerometer data using artificial intelligence configured to perform gait recognition of a user.
